(19) United States
(12) Patent Application Publication
(10) Pub. No.: US 2005/0192089 A1
(43) Pub. Date: Sep. 1, 2005

(54) System and method of using cards to provide access to features of video game machines

(76) Inventors: Karl Thomas Blatter, Rolling Meadows, IL (US); Brian William Necker, Berwyn, IL (US); Jane D. Siegrist, West Chicago, IL (US); Gary Colabuono, Arlington Heights, IL (US); Randy Syd Demsetz, Algonquin, IL (US); R. Scott Morrison, Mundelein, IL (US); Sheri Lynn Pocilujko, Hoffman Estates, IL (US); Lawrence J. Hodgson, Kildeer, IL (US)

Correspondence Address: WELSH & KATZ, LTD, 120 S RIVERSIDE PLAZA, 22ND FLOOR, CHICAGO, IL, 60606, US

(21) Appl. No.: 10/976,948

(22) Filed: Oct. 29, 2004

Related U.S. Application Data
(60) Provisional application No. 60/515,762, filed on Oct. 30, 2003.

(51) Int. Cl. G06F 17/00; G06F 19/00

(52) U.S. Cl. 463/29

(57) ABSTRACT

A video game or other amusement/entertainment device has a card reader that can be used to establish game play credits. The reader can also be used as an input device to communicate control codes to the game or other amusement/entertainment device control unit. The control codes can direct the control unit to switch from a normal game play or other amusement/entertainment mode to at least one alternate mode for special promotions, tournaments or the like. Alternately, the control codes can cause the game or other amusement/entertainment machine to enter maintenance or administrative modes.

### CROSS REFERENCE TO RELATED APPLICATIONS

The benefit of the filing date of Oct. 30, 2003 of Provisional Application No. 60/515,762 entitled “System and Method of Using Cards to Provide Access to Features of Video Game Machines” is hereby claimed.

### FIELD OF THE INVENTION

The invention pertains to systems and methods of controlling electrical devices which might be used by multiple individuals. More particularly, the invention pertains to establishing the operational characteristics of video games or other amusement/entertainment devices using control cards and associated software.

### BACKGROUND OF THE INVENTION

Video game machines and other amusement/entertainment devices typically include a variety of publicly available features which players can access after establishing an appropriate credit via coins or cards. A user or game player can establish the necessary game/entertainment play credit(s) by using coins or a credit card. Such credits cause the respective machine to carry out its standard game/entertainment play sequence for the benefit of the player who has established the credit(s).

Operators of such machines may from time to time conduct special promotions or enable the players to use the respective machine(s) in other than the normal, publicly available mode. Non-operator promoters may also want to conduct special promotions or contests using the respective game(s). One way this can be done is to provide various mode setting switches that the operator can access to enable the desired special operational mode(s). While feasible, this approach requires special hardware. It also requires that the switches be located in a secured region of the game to preclude unauthorized access thereto. The need to access special hardware also limits the promoter's ability to carry out contests or promotions without the operator.

It would be desirable to be able to control machine operational mode(s) without having to open a portion of a cabinet thereby providing access to a secure switch location. It would also be preferable to minimize any need for special, or expensive, mode setting tools or equipment. Finally, it would be desirable to quickly switch operational modes so as not to interfere with the machine's revenue stream.

It has also been recognized that there are numerous advantages in being able to network games. Such networks can be configured as local intranets. Alternately a more extensive computer network, such as the Internet, can be used for game/equipment communication and/or control.

One network system is described in U.S. patent application Ser. No. 10/662,891 filed Sep. 15, 2003 entitled “Data Delivery and Management System and Method for Game Machines”, assigned to the assignee of the present application and incorporated herein by reference. Another is described in U.S. patent application Ser. No. 10/935,296 filed Sep. 7, 2004, entitled “Games with Wireless Communications Capabilities” assigned to the assignee of the present application and incorporated herein by reference.

It would be advantageous to both operators and promoters to be able to carry out the desired promotional activities while also obtaining benefits, such as collection of promotion game play/usage information, statistics and the like as well as reports, afforded by networked games.

### BRIEF DESCRIPTION OF DRAWING

FIG. 1 is a block diagram of a system in accordance with the invention;

FIG. 2 is a block diagram of a video game usable with the system of FIG. 1; and

FIG. 3A, 3B taken together illustrate a flow diagram of an exemplary process of operating the system of FIG. 1; and game of FIG. 2.

### DETAILED DESCRIPTION OF THE INVENTION

While embodiments of this invention can take many different forms, specific embodiments thereof are shown in the drawings and will be described herein in detail with the understanding that the present disclosure is to be considered as an exemplification of the principles of the invention, as well as the best mode of practicing same, and is not intended to limit the invention to the specific embodiment illustrated.

In a disclosed embodiment, special features or operational modes of an electrical unit, such as a video game, can be accessed or selected using a card reader carried on the unit or game. This solution has the advantage that is software based and does not need added hardware.

In one aspect, the operator(s) or event promoter(s) can be provided with special control cards created or made available by the game machine's manufacturer. These cards enable the possessor of the card, for example, the machine owner, the site operator or an outside promoter, to put the game into a special mode, or perform a special function.

Player cards can be provided, which for example could be usable only after the operator had used one of the control cards to place the respective machine into one of the special modes of operation. The cards can be used in advertising or promotional campaigns.

Promotional or advertiser cards could enable, for example, a special game mode for example, “Closest to the Pin”, within a golf game. Alternately, Sweepstakes cards could be distributed to players.

In another aspect, “Closest to the Pin” cards can be used to put a golf game machine into a timed rental mode. The user of the card can pay to rent the machine for a period of time during which it only runs a “Closest to the Pin” contest, or any other contest.

Once the control card has been swiped during the attract mode, a screen can be displayed that requests an amount of money to be entered to start the “Closest to the Pin” timed rental mode. Once the money has been entered, the request can be confirmed. The game then re-boots into “Closest to the Pin” mode, where players take shots on holes in which a hole-in-one is possible. The game keeps track of the player who has shot closest to the pin (hole). The operator can award prizes as appropriate. Statistics and game play information concerning the contest can be transmitted from the respective game, if networked, to a database for storage and report generation.

Sweepstakes cards implement a contest in which cards can be given out, some of which are encoded with winning data. Such cards can be used by players, for example, in connection with a variety of game machines such as golf, bowling, shooting gallery, hunting or vehicle (car, boat, plane) operational games.

Another type of card, Tournament Organizer cards put the respective game machine into a mode in which every league game started in this manner has the same conditions during that day (6 a.m. to 6 a.m.). When the card is swiped, for example while the machine is in the attract mode, the game enters the selected mode. In this mode, it can disallow other modes, for example, one player games, or game type selection features. Once the game is over the respective machine returns to a normal mode of operation.

In combination with the game play activities, the respective games can communicate, via the Internet, to an appropriate remote server. Statistics concerning the game play activities can be collected in real-time or substantially in real-time. Reports can be generated and forwarded to the organizers of the contest or activity.

Exemplary data which can be encoded on the “Closest to the Pin” type of card:

| Field Name | Size | Format | Description |
|---|---|---|---|
| Advertiser ID | 9 | numeric | 9 Digit Advertiser ID |
| Feature Type | 6 | alpha-numeric | Indicates Closest |
| | | | to the Pin |
| Expiration Month | 1 | alpha-numeric | Expiration Month |
| | | | (1-12) (‘A’-‘L’) |
| Expiration Day | 1 | alpha-numeric | Expiration Day |
| | | | (1-31)(‘1’-‘9’, ‘A’-‘V’) |
| Expiration Year | 4 | alpha-numeric | Expiration Year |
| | | | (example: 1970) |
| Sequential ID | 6 | alpha-numeric | Unique ID to track |
| | | | owner of card |
| Win Lose Flag | 1 | alpha-numeric | Not used |

Exemplary data which can be encoded on the Sweepstakes type of card:

| Field Name | Size | Format | Description |
|---|---|---|---|
| Advertiser ID | 9 | numeric | 9 Digit Advertiser ID |
| Feature Type | 6 | alpha-numeric | Indicates Sweepstakes |
| Expiration Month | 1 | alpha-numeric | Expiration Month |
| | | | (1-12) (‘A’-‘L’) |
| Expiration Day | 1 | alpha-numeric | Expiration Day |
| | | | (1-31)(‘1’-‘9’, ‘A’-‘V’) |
| Expiration Year | 4 | alpha-numeric | Expiration Year |
| | | | (example: 1970) |
| Sequential ID | 6 | alpha-numeric | Unique ID to track |
| | | | owner of card |
| Win Lose Flag | 1 | alpha-numeric | Encoding of if |
| | | | a winning card |

Exemplary data which can be encoded on the Tournament Organizer type of card:

| # of | | |
|---|---|---|
| Characters | Format | Description |
| 9 | numeric | 9 Digit Tournament Organizer ID |
| 1 | alpha-numeric | Expiration Month (1-12) (‘A’-‘L’) |
| 1 | alpha-numeric | Expiration Day (1-31)(‘1’-‘9’, ‘A’-‘V’) |
| 4 | alpha-numeric | Expiration Year (example: 1970) |
| <=12 | alpha-numeric+ | First Name |
| 1 | alpha-numeric+ | Last Initial |

In such special modes an end of game score screen can be held for a period of time, such as 5 minutes or until the card is swiped again. This holding period allows the tournament organizer to manually record the score of the game, if desired.

A unique contest ID and a tournament organizer ID can be included in the game play data for a game played using the Tournament Organizer card. Such data can be sent to any network to which the game machine is coupled. One such network is ITNet, a game machine network owned by Incredible Technologies, Inc.

It will be understood that the above are exemplary only. Other maintenance or administrative modes or special contests could be implemented using machine readable control cards without departing from the spirit and scope of the present method, system and invention.

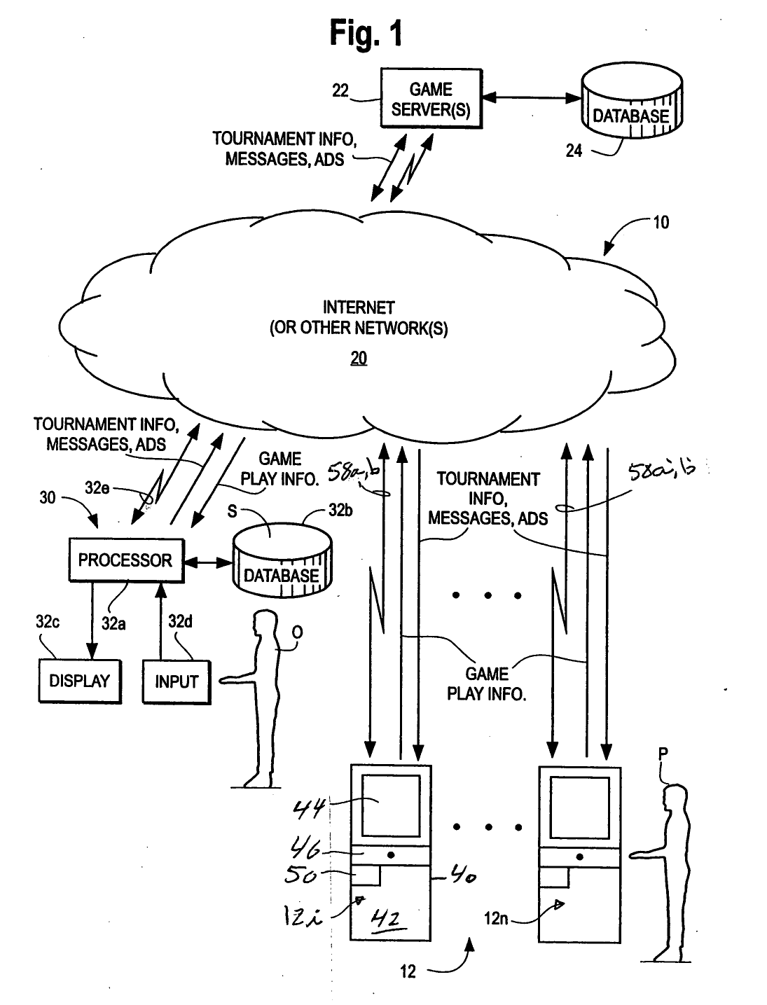

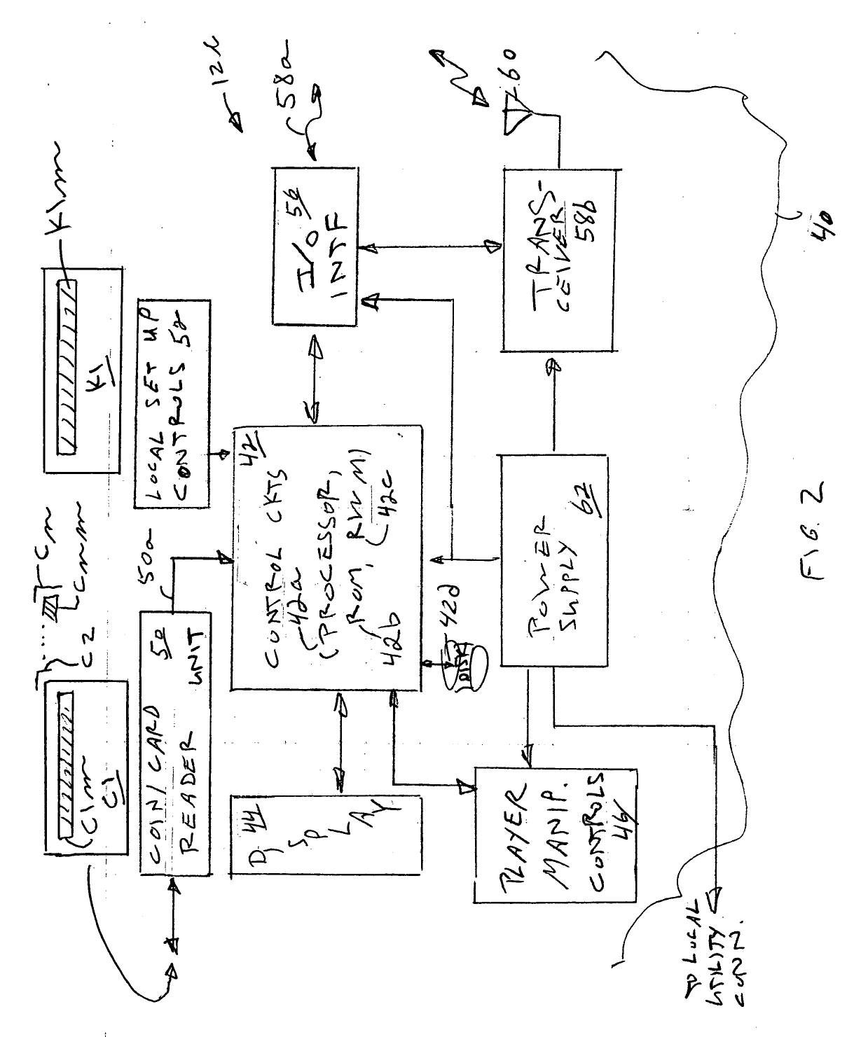

FIG. 1 illustrates a networked system 10 in accordance with the present invention. The system 10 incorporates a plurality of game machines, which could be substantially the same or could be different, all without limitation, 12i . . . 12n.

In a normal game play mode, each of the machines is designed and intended to enable to enable a player or players P to engage in or play a game of the type provided by such game machines. For example, and without limitation, the game machines 12i . . . n could enable the players P to play various different golf courses as well as games with different rules. Alternately, the machines 12i . . . n could enable the players P to play baseball, bowl, safari or hunt. Other types of games of skill such as vehicular racing, shooting galleries and the like come within the scope and spirit of the present invention.

One type of game machine usable with the system 10 is the GOLDEN TEE brand electronic golf games marketed by the assignee hereof. Subsequent references to golf, golf courses, tournaments, rules or the like, are exemplary only. They are for the purpose of describing embodiments of the invention so as to enable those of skill in the art to make and use same, and for the purpose of disclosing the best mode of practicing same. They are not limitations of the invention.

The machines 12i . . . n can be intermittently or continually linked, via communication channels such as, for example, dial-up telephone lines to a network, such as the internet 20. One or more machines can share a given communication link since none of the members of the plurality 12i . . . n need carry-on continuous communication via the respective link. Alternately, such communications can be carried out wirelessly.

The game machines 12i . . . n can initiate bidirectional communication, via the internet or other networks 20, with one or more game servers 22. The game servers 22 support a game-related database 24 which can be continually or periodically up-dated with information by transmissions initiated via one or more of the game machines 12i . . . n.

The game server 22 can in turn download to the respective game machines 12a . . . 12n information temporarily stored in database 24 when the respective game machine communicates with the server 22. It will be understood that communication details between the game machines 12i . . . 12n, network 20 and game server 22 are not limitations of the present invention.

It will also be understood that game play information or data from the respective game play machines 12i . . . 12n can be up-loaded to the server 22 and database 24, via network 20, on an intermittent basis when the respective game machine initiates communication with the server or substantially continuously.

An operator's computer system 30 incorporates a processor 32a, associated with database 32b, display 32c and input devices such as keyboards, touch screens, track balls, mice and the like 32d, all without limitation. The operator computer system 30 can be placed into intermittent communication via the network 20, over a link 32e with game server 22. In this circumstance, game play information up-loaded from the game machines 12a . . . n stored in database 24 can be downloaded by the link 32e to the operator's computer 30 for local storage in database 32. Once the operator O has obtained the necessary information, he/she can operate off-line to carry out various of the functions as described below.

Player information can be retrieved from server 22. Messages and leaderboards can be sent, via the network 20 directly to online machines 12i . . . n.

Operator software S executed at processor 32a enables the operator or owner to create a variety of contests and promotions. If desired, the software tool S could be downloaded from server 22 and stored locally 32b for execution at the operator's convenience.

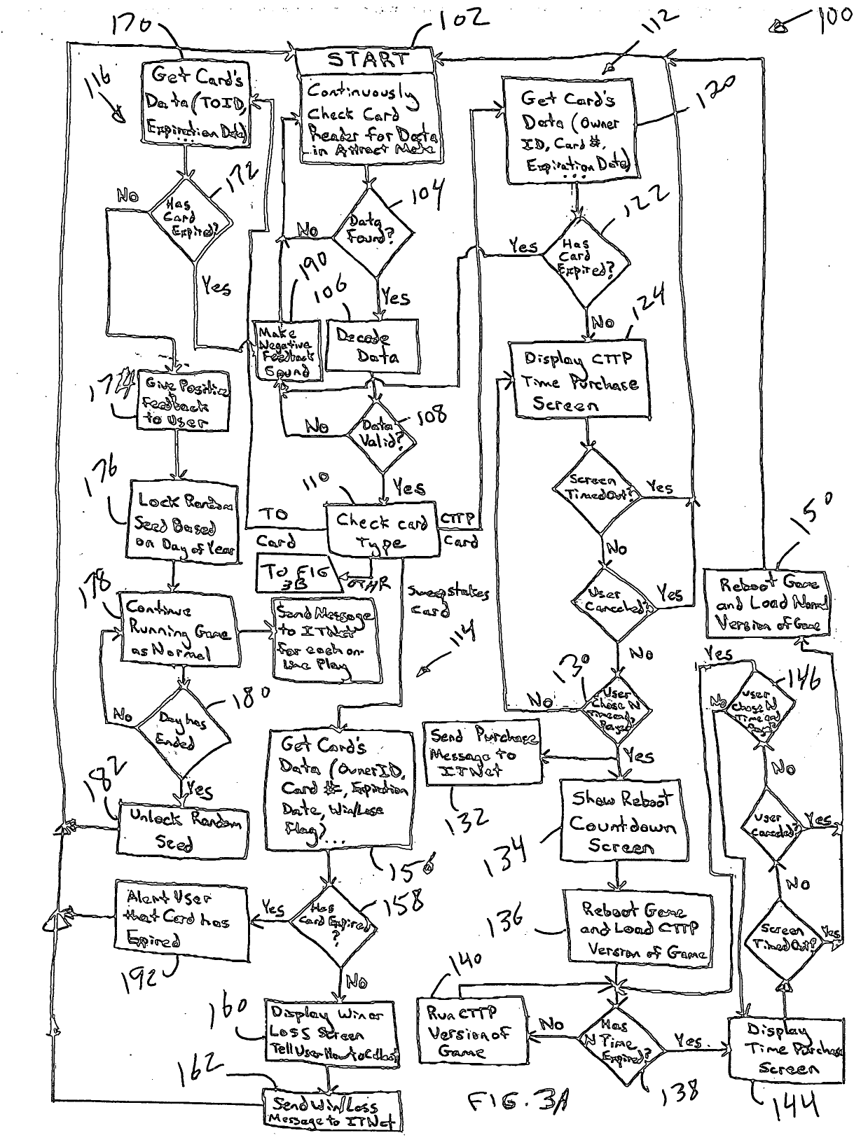

FIG. 2 illustrates more details of a representative one of the video games, such as game 12i of FIG. 1. The game 12i is enclosed in a cabinet 40 and includes control circuitry 42 which could be implemented, at least in part, with a programmable processor 42a and control programs, at least in part, stored on read-only memory 42b. Read-write memory 42c is provided for temporary storage. The control circuits 42 are coupled to a display 44 and player manipulatable controls 46, for example, a track ball, buttons, switches and the like. The control circuits 42 are also coupled to a coin/currency and card reading credit establishing unit 50. Switches and other manually adjustable controls 52 enable a game installer to provide a set of initial parameters for the game 12i. If desired, a disk drive 42d on which control programs can be stored, can be coupled to control circuits 42.

Control circuits 42 are also in bi-directional communication with an input/output interface 56. Interface 56 is in turn coupled to a wired link such as a telephone line 58a, or a wireless transceiver 58b. The wired link couples the game to network 20 via a switched telephone network.

The transceiver 58b transmits and receives wireless RF signals to and from network 20 via antenna 60. A power supply 62 energizes the various circuits and units of the game 12i.

The game 12i can be controlled, in accordance with the invention, via one or more magnetic stripe control cards C1, C2 . . . Cn. The control cards C1 . . . Cn differ from an ordinary credit/debit card K1 of a type that might be used to establish a game play credit(s) in the game 12i. Credit/debit cards K1 provide credit or debit account information pre-recorded on magnetic stripe K1m, which can be used to establish the necessary credits to obtain access to the game play features of the game 12i.

Unlike credit/debit card K1, the family of control cards C1 . . . Cn enables a game owner or operator, a facility owner or operator, or a promoter, to place the game 12i, as well as any of the other games . . . 12n in a particular mode, which is different from the respective game's normal game play mode.

The coin/card reader unit 50 could be implemented, for example, using a magnetic card reader in combination with a coin/currency receipt mechanism. The card reader portion of the unit 50 can read account information off of the credit/debit card K1 in a conventional fashion for purposes of establishing the necessary credits to operate the machine 12i.

The card reader 50 can alternately read control information off of one or more of the control cards C1, C2 . . . Cn. Such information can be stored on a respective magnetic stripe, such as C1m, C2m . . . Cnm. The type of information which can be recorded on the respective magnetic stripe differs from the information recorded on the credit/debit card K1.

For example, and without limitation, information recordable on the control cards C1, C2 . . . Cn, could include identification of a particular game play mode, such as “Closest To The Pin” for a golf game, or a particular form of a drag race for a vehicular driving game. Information carried on the respective control card could also include an advertiser or promoter identification code, game or mode designation code, expiration codes, card identification codes, as well as any other information of interest relative to the particular type of promotion or contest to be carried out.

The prestored control programs in the read-only memory 42b, and/or disk drive 42d, for example, respond to electrical signals from the unit 50, lines 50a, which are indicative of information read off of the respective control card, such as card C1. Circuitry 42, in combination with the prestored executable instructions can, upon analysis of the information received from the respective control card, enter the designated operational mode for carrying out the promotion or contest such as the above-noted “Closest To The Pin” golf game, or the above-noted drag race, which could be experienced on a driving game. In combination with entering the designated mode, the control circuitry 42a can request an additional or special credit via the coin/card reader unit 50 before enabling the player to actually experience the game play sequence. Other maintenance or administrative modes could be entered accordingly.

It will be understood that control circuitry 42a along with the prestored instructions, can respond differently to each one of a plurality of different control cards C1, C2 . . . Cn. Those cards can be distributed to different location operators or promoters to cause the respective machines, such as the machine 12i to enter a variety of different modes (some of which might be proprietary to various locations or promoters). Once the time interval associated with the particular mode has passed, the game 12i can automatically revert to its normal mode of operation. Alternately, a second use of the control card Ci can be required to exit the established promotional mode.

During and after the time interval in which the game 12i is operating in a promotional mode, information pertaining to the control card Ci as well as game play information, statistics and the like, can be forwarded via interface 56, by either wired connection 58a or wirelessly 58b to the associated network 20 for storage at the game server 22 and database 24. All such information can subsequently be provided to the owner, location operator or the promoter in the form of electronic or hard copy reports indicative of the number of game activities scores and statistics associated with each promotion. The reports can be broken down by control card Ci identifier, location, mode, or the like, all without limitation. The noted control cards can be formed of a planar plastic body which carries a data recording region, magnetic or optical.

While the game 12i has been described relative to magnetic stripe cards Ci, K1, and magnetic card reader 50, it will be understood that the invention is not so limited. Optically based cards and readers, all without limitation come within the spirit and scope of the invention. The noted control cards can be formed of a planar plastic body which carries a data recording region, magnetic or optical without limitation.

It will also be understood that the cards Ci can be used to cause the machine 12i (or any of the other machines in the plurality 12) to enter a maintenance or administrative mode. In the maintenance mode(s) machine operation can be evaluated. In the administrative mode(s) accounting information or game play statistics can be presented on display 44. Other modes come within the spirit and scope of the invention.

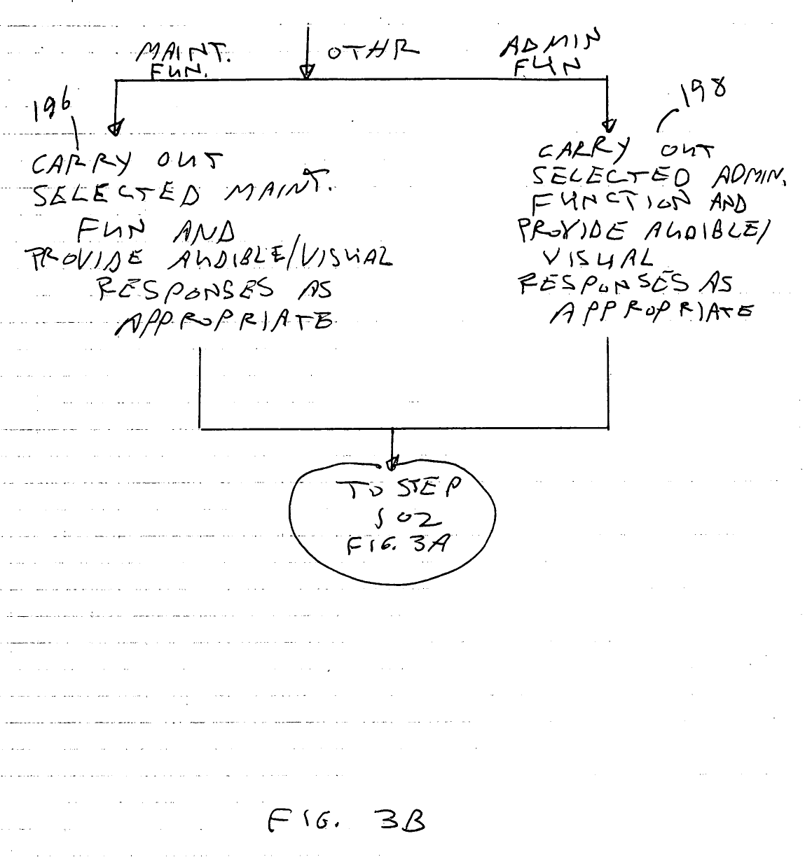

FIG. 3A, B taken together illustrate steps of a method 100 in accordance with the present invention. In a step 102, the game control software continuously checks the card reader 50 for incoming data. While in step 102 the game is in the attract mode. If data is received, step 104, it is decoded in a step 106.

Validity of data is examined in step 108. Valid data is then checked to determined the type of card which has been swiped, step 110.

If the designated mode corresponds to the CTTP mode, “Closest To The Pin” type game, branch 112 is executed. If it is a sweepstakes type card, branch 114 is executed. If it is a tournament type card, branch 116 is executed. Finally, modes defined by other types of control cards are described in FIG. 3B.

In the “Closest To The Pin” type mode, branch 112, the card's data such as owner ID, card number, expiration date and any other related data are evaluated and the appropriate data stored, step 120. If the card has not expired, step 122, the game displays a CTTP time purchase screen, step 124. The screen requests a deposit or credit to rent the game for a period of time for the CTTP promotion. If the screen has not timed out, the user has not cancelled, but has in fact deposited the required finds or swiped a credit or debit card, step 130, the CCT mode is enabled.

In a step 132 the purchase information is forwarded to the local network. In step 134 the game displays an introductory CTTP feedback and countdown screen. The game is then loaded and initiated for execution, step 136. If the rental time has not expired, step 138, the CTTP version of the game is then run or executed for the prepaid interval, step 140 until the time interval has expired.

On expiration of the prepaid time interval, the time purchase screen is again displayed requesting additional funds, step 144. If additional funds are deposited or credited, step 146, game play continues, step 140. Otherwise the time purchase screen is again displayed. When the CTTP mode expires, times out or the like, the game reverts to its normal game play attract screen and game play functionality, step 150.

Where a sweepstakes card has been detected, as illustrated in branch 114, the card's data such as owner ID, card number and expiration date and other information is obtained, step 156. If the card has not expired, the win or loss status of the card is presented, display 44, and the user is advised as to how to collect his or her prize, step 160. The win/loss information is also sent to the game network 162. Subsequently, the game returns to the attract mode step 102.

Responding to a detected tournament card, and branch 116, information is read from the card including tournament ID, expiration date and related information as would be understood by those of skill in the art, step 170. If the card has not expired, the user is presented with a screen indicating that tournament play can proceed, step 174.

The game selects a particular form of tournament contest on a random basis, step 176. It will be understood that the exact nature of the random selection of the tournament activity is not a limitation of the present invention. It can be based on the day of the year, it can be based on a random number generator, all without limitation.

In a step 178, the tournament contest is carried out in accordance with the characteristics of the selected contest. For example, a golf tournament can be conducted on a randomly selected course. A vehicular driving race can be run on a randomly selected track.

Where the contest has been designed to run on or during only a single day, once the day has ended, step 180, the game is unlocked from its tournament status, whatever that might be, and it reverts to its normal game play attract mode step 102. In various steps, such as 122, 158 and 172, where the respective control card has expired for any reason as would be understood by those of skill in the art, the system so advises the player either verbally, optically or both, step 190 or 192. Subsequently, the game returns to its attract mode step 102.

Where the control card type is “other” as illustrated in FIG. 3B, if the control code defines a maintenance function, the maintenance function that is requested is carried out in step 196. Any or all of the standard maintenance functions of the respective game can be accessed via an appropriate control card(s). Alternately, if an administrative function has been defined by the control card, the defined function is carried out in a step 198. Administrative functions could include without limitation presenting game play statistics and data on the display 44, providing financial information as to the receipts of the game over some time interval or the like, all without limitation. Upon completion of either the selected maintenance function or administrative function, the game reverts to its attract mode step 102, FIG. 3A.

It will be understood that methodology disclosed and described relative to FIGS. 3A and 3B is exemplary only. Variations thereof come within the spirit and scope of the present invention.

It will be also be understood that the type of game or entertainment/amusement device is not a limitation of the invention. Jukeboxes, countertop units or other devices for amusement or entertainment, including internet enabled games or the like all without limitation, can include card driven mode selection, maintenance function or administrative function specification in accordance herewith all without limitation.

Those of skill will also understand that a virtual screen can be presented on a display. Mode selecting, maintenance function or administrative function specification can be implemented using the virtual keyboards. In this embodiment, a physical control card will not be necessary.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

1. An amusement/entertainment device comprising:
a control unit which includes at least one two dimensional visual display;
a card reader coupled to the control unit;
a control program coupled to the control unit, the control program carries out a game play function, and responsive to information carrying signals received from the card reader, enters at least one operational mode designated by the information carrying signals.

2. A device as in claim 1 where the control program, responsive to information carrying signals received from the card reader, enters one of a plurality of operational modes.

3. A device as in claim 1 where the control program responds to at least one of game play or other operational credit signals to enable a user to interact with the game in the at least one operational mode.

4. A device as in claim 1 where the control program then enables a user to interact with the device in at least one operational mode.

5. A device as in claim 1 where the control program presents at least one of a visual, audible, or combination visual and audible, interactive operating sequence in accordance with the at least one operational mode.

6. A device as in claim 5 where the interactive operational sequence comprises one of a contest, a golf contest, a hunting sequence, an audible experience, a vehicular driving sequence, or other amusement/entertainment experience, the operational sequence being determined, at least in part, by the at least one operational mode.

7. A device as in claim 2 where the plurality of operational modes comprises a plurality of different golf related game activities.

8. A device as in claim 2 which includes at least one mode setting card, the card carries a plurality of mode specifying indicia.

9. A device as in claim 8 where the card carries an identifier.

10. A device as in claim 9 where the control program receives both the mode specifying indicia and the identifier.

11. A device as in claim 10 which includes a communications program for at least intermittently communicating with a remote data base via a computer network.

12. A device as in claim 11 where the control program includes instructions for forwarding card related indicia to the remote data base.

13. A device as in claim 12 where the control program carries out at least one of a game play or other function in accordance with the selected one operational mode.

14. A device as in claim 1 where the information carried by the signals comprises at least an operational mode designator and a card identifier.

15. A device as in claim 14 which includes a communications program for at least intermittently communicating with a remote data base via a computer network.

16. A device as in claim 15 where the control program includes instructions for forwarding card related indicia to the remote data base.

17. A device as in claim 16 where the control program carries out a game play or other function in accordance with the selected operational mode.

18. Amusement/entertainment device control software comprising:
card reader software coupled to amusement/entertainment device control software, the control software responds to mode specifying indicia received from the card reader software to carry out at least one of a game play or other process in accordance with the mode specifying indicia.

19. Software as in claim 18 where the device control software accumulates game play or other statistics associated with the games played or other activities in accordance with the mode specifying indicia.

20. Software as in claim 18 where the control software receives a designation from the card reader software indicative of an entity that is specifying the mode.

21. Software as in claim 20 which includes communications software for transferring the designator and game play or other statistics for the specified mode to a displaced location.

22. A method of operating an amusement/entertainment device comprising:
establishing a plurality of game play or other sequences;
providing a planar play sequence specifying member;
sensing off of the member the specified play or operational sequence.
requesting a game play or other credit in response to the specified play sequence; and
enabling the specified game play or other sequence when the credit has been established.

23. A method as in claim 22 which includes:
presenting at least one of a two dimensional display and/or audible airing of the specified game play or other sequence.

24. A method as in claim 22 which includes:
communicating at least one of the specified play or other sequence via a computer network, to a remote data base.

25. A method as in claim 24 which includes coupling a member designator to the remote data base.

26. A method as in claim 25 which includes producing at least one of game play or other related reports associated with the member designator.

27. A video game control card comprising:
a planar member;
game mode specifying indicia carried on the member.

28. A control card as in claim 27 where the mode specifying indicia comprises one of magnetic, or, optically encoded indicia.

29. A card as in claim 28 which includes card identifier indicia.

30. A system comprising:
at least one computer based amusement/entertainment machine, the machine having a multi-dimensional display, audio, a card reader and a communications port for communicating with a displaced computer system via a computer network; and
information receiving software operative at the displaced computer system to receive at least one of game play or other mode data as well as card identification data associated with the at least one game machine.

31. A system as in claim 30 where the at least one amusement/entertainment machine includes first software for receipt of card related information from the card reader.

32. A system as in claim 31 where the at least one amusement/entertainment machine includes second software for establishing an operational game play or other mode of the at least one game machine.

33. A system as in claim 31 where at least one amusement/entertainment machine includes determination software, responsive to received card related information, for placing the machine into one of a game play mode, a non-game play administrative mode, or a non-game play maintenance mode or other mode.

34. A system as in claim 31 which includes second software to analyze information received from the card reader, and, responsive thereto to enter one of a plurality of game play or other modes.

35. A system as in claim 34 where the second software receives card identifier information from the card reader.

36. A system as in claim 35 which includes additional software for forwarding at least the card identifier information and entered game play or other mode, via the communications port, to the displaced computer system.

37. A system comprising:
at least one computer based amusement machine, the machine having at least an audio output, a card reader and a communications port for communicating with a displaced computer system via a computer network; and
information receiving software operative at the displaced computer system to receive machine operational data as well as card identification data associated with the at least one machine.

38. A system as in claim 37 where the machine includes a multi-dimensional display.
